(19) United States
(12) Patent Application Publication
(10) Pub. No.: US 2016/0252438 A1
(43) Pub. Date: Sep. 1, 2016

(54) METHOD FOR LOCATING IMPACT AREA OF COMPOSITE STRUCTURE BASED ON ENERGY WEIGHTED FACTOR

(71) Applicant: NANJING UNIVERSITY OF AERONAUTICS AND ASTRONAUTICS, Jiangsu (CN)

(72) Inventors: Shenfang YUAN, Nanjing, Jiangsu (CN); Lei QIU, Nanjing, Jiangsu (CN); Yuanqiang REN, Nanjing, Jiangsu (CN); Hanfei MEI, Nanjing, Jiangsu (CN); Shang GAO, Nanjing, Jiangsu (CN)

(21) Appl. No.: 14/767,467

(22) PCT Filed: Nov. 10, 2014
(86) PCT No.: PCT/CN2014/088641

§ 371 Date: Aug. 12, 2015

(30) Foreign Application Priority Data
Sep. 9, 2014 (CN) 201410455126.8

(51) Int. Cl. G01N 3/30; B64C 39/02; B64D 45/00; G01D 5/02; G01N 3/02

(52) U.S. Cl. CPC G01N 3/30; G01D 5/02; G01N 3/02; B64D 45/00; B64C 39/024; B64D 2045/0085; B64C 2001/0072

(57) ABSTRACT

The present invention discloses a method for locating an impact area of a composite structure based on an energy weighted factor, which belongs to the field of structural health monitoring technologies. According to the characteristic that the closest a sensor in an impact occurring sub-area is to the impact position, the most the sensor is affected by the impact, the present invention defines a characteristic parameter of the energy weighted factor, to represent the degree that each sensor is affected by the impact within the entire impact monitoring range, then calculates the degree that each sub-area is affected by the impact within the monitoring range, and finally determines that the sub-area most affected is the impact occurring sub-area. The present invention solves the problems of localization confliction of adjacent nodes and locating blind zones of mid-areas arising during existing multi-node large-scale networking monitoring; the method unites a plurality of nodes to jointly perform impact monitoring through networking, can quickly and accurately perform impact localization on all sub-areas within the network monitoring range, and has good application prospects in the aspect of impact monitoring of large-scale composite structures.

### FIELD OF THE INVENTION

The present invention relates to a method for locating an impact area of a composite structure, and belongs to the field of structural health monitoring technologies.

### DESCRIPTION OF RELATED ART

Compared with conventional metal materials, composite materials have the following advantages: great specific stiffness, strong resistance to fatigue and corrosion and flexible design, and thus are heavily used in aircraft structures. However, the composite materials' poor resistance to impact is easy to lead to sharp decrease of mechanical properties thereof. For aircraft composite structures, an impact may occur in the process of manufacturing, service and maintenance, and is almost inevitable in the entire life cycle. Therefore, it is very important to perform onboard and online impact monitoring on the aircraft composite structures.

A traditional structural health monitoring system, during impact monitoring, pursues high locating accuracy, and thus the system often has higher requirements for software and hardware configuration, resulting in that the system has a large volume and high power consumption and cannot meet onboard requirements. Digital impact monitoring nodes directly convert impact response signals of impact sensors to digital sequences, and extract corresponding characteristic parameters therefrom to achieve localization of impact areas, thus greatly simplifying the system, having advantages such as a small volume, light weight and low power consumption, and meeting the requirements of onboard and online monitoring.

Real aircrafts often have multiple large-area composite structures which require impact monitoring, for example, wings, fuselages and vertical tails, and thus it is often necessary to use a plurality of impact monitoring nodes for networking monitoring. However, when a plurality of monitoring nodes perform large-scale networking impact monitoring on the same structure, the following two problems exist:

(1) When monitoring areas of the plurality of monitoring nodes are adjacent to each other, an impact occurring in one area may trigger other nodes to perform impact monitoring, and if each node locates the impact separately, it will lead to a localization confliction. Therefore, in actual applications, an impact localization algorithm is required to eliminate the confliction, and impact records of a plurality of nodes are united to jointly judge a correct impact occurring sub-area.

(2) Adjacent monitoring areas often have mid-areas therebetween, and the mid-areas do not belong to the monitoring range of any node, but also require impact monitoring. The localization algorithm operating in a single node can only perform impact monitoring and localization on sub-areas within the monitoring range of the node, but the mid-areas cannot be located. Thus, a new impact localization algorithm is needed to recognize and locate impacts occurring on the mid-areas.

### SUMMARY OF THE INVENTION

### Technical Problem

The technical problem to be solved by the present invention is to provide a method for locating an impact area of a composite structure based on an energy weighted factor so as to overcome technical deficiencies, which can effectively solve the localization confliction problem existing in existing technologies of impact monitoring of multi-monitoring-node networking and the problem that it is difficult to accurately locate mid-areas, and performs quick and accurate impact localization.

### Technical Solution

The present invention specifically adopts the following technical solution:

A method for locating an impact area of a composite structure based on an energy weighted factor, wherein at least two groups of impact sensor arrays are disposed in an impact monitoring area on the surface of a composite structure, the two groups of impact sensor arrays each are respectively in a signal connection with a monitoring node, and the monitoring nodes are in a signal connection with the same monitoring center; the method for locating an impact occurring sub-area includes the following steps:

step A. using the position of each impact sensor disposed on the surface of the composite structure as a grid vertex, to grid-partition the impact monitoring area;

step B. when an impact occurs, receiving, by each one of n monitoring nodes triggered, an impact response signal digital sequence of each impact sensor connected therewith, and selecting first M impact sensors where the first signal rising edge in the impact response signal digital sequence arrives first, M being the number of vertices of a single grid cell partitioned in step A; then calculating respective energy weighted factors of the M impact sensors, and sending a calculation result to the monitoring center; the energy weighted factors of the impact sensors being calculated according to the following formula:

$$E W F = \frac{D R}{I F R E}$$

in the formula, EWF is the energy weighted factor of an impact sensor. IFRE, index of the first rising edge, is a sequence number of arrival time of the first rising edge in the impact response signal digital sequence of the impact sensor in the M impact sensors, and DR, duration of the rises, is the sum of durations of all signal rising edges in the impact response signal digital sequence of the impact sensor;
step C. selecting, by the monitoring center, first M ones in the n×M impact sensors with the greatest energy weighted factor value, keeping the energy weighted factor values of the M impact sensors unchanged, and setting the energy weighted factor values of all the remaining impact sensors as 0; and
step D. determining, by the monitoring center, a sub-area where the impact occurs according to the sum of energy weighted factors of impact sensors at M vertices of each grid cell in the impact monitoring area; the grid cell with the greatest sum of energy weighted factors being the sub-area where the impact occurs.

### Advantageous Effect

Compared with the existing technologies, the technical solution of the present invention has the following beneficial effects:

The present invention provides a multi-node joint locating method for networking monitoring of a plurality of impact monitoring nodes, solves the localization confliction problem arising when the monitoring areas of a plurality of nodes are adjacent to each other, and can accurately perform impact localization on mid-areas. The present invention also has the advantages of simple algorithm, quick localization speed and low requirements for software and hardware.

### BRIEF DESCRIPTION OF THE DRAWINGS

FIG. 1 is a schematic flowchart of a method for locating an impact area of a composite structure according to the present invention;

FIG. 2 is a schematic view of the first rising edge and the duration of the rising edge of a digital sequence;

FIG. 3 is a schematic view of the arrangement of an impact monitoring system of a composite unmanned aerial vehicle (UAV) wing structure;

FIG. 4 is a view of distribution of energy weighted factors of 8 sensors where the first rising edge arrives first; and

FIG. 5 is a view of distribution of the sums of respective energy weighted factors of 25 monitoring sub-areas.

### DETAILED DESCRIPTION OF THE INVENTION

The technical solution of the present invention is described below in detail with reference to the accompanying drawings.

The basic idea of the present invention is, according to the characteristic that the closest a sensor in an impact occurring sub-area is to the impact position, the most the sensor is affected by the impact, defining a characteristic parameter called energy weighted factor, to represent the degree that each sensor is affected by the impact within the entire impact monitoring range, then calculating the degree that each sub-area is affected by the impact within the monitoring range, and finally determining that the sub-area most affected is the impact occurring sub-area. The present invention uniformly evaluates degrees of effects of the impact on respective impact monitoring sub-areas from a perspective which is global and not limited to a single node monitoring range in the above manner, and uniformly restores the problems of localization confliction of adjacent nodes and mid-areas locating arising during large-scale networking monitoring of a plurality of impact monitoring nodes back to the problem of estimating degrees of effects of the impact on every monitoring sub-area, and effectively solves the two problems.

Suppose that a plurality of impact monitoring nodes are disposed in a composite structure to be monitored to form a monitoring network, and impact monitoring is performed on the entire monitoring area; wherein each monitoring node is connected to a sensor array consisting of a plurality of impact sensors, and the monitoring nodes all can exchange information with the monitoring center.

The entire monitoring area is previously divided into a series of sub-areas not overlapping with each other through grid partition, that is, the position of each impact sensor is taken as a grid vertex, to grid-partition the impact monitoring area. The specific manner of grid partition may be flexibly selected in combination with actual arrangement of sensors, for example, a triangular grid, a quadrilateral grid, or a hexagonal grid may be adopted, when the manner of triangular grid partition is adopted, every 3 adjacent impact sensors are used as vertices of a grid cell, the grid cell corresponding thereto is a sub-area, and similarly, when a quadrilateral grid is adopted, each grid cell has four vertices.

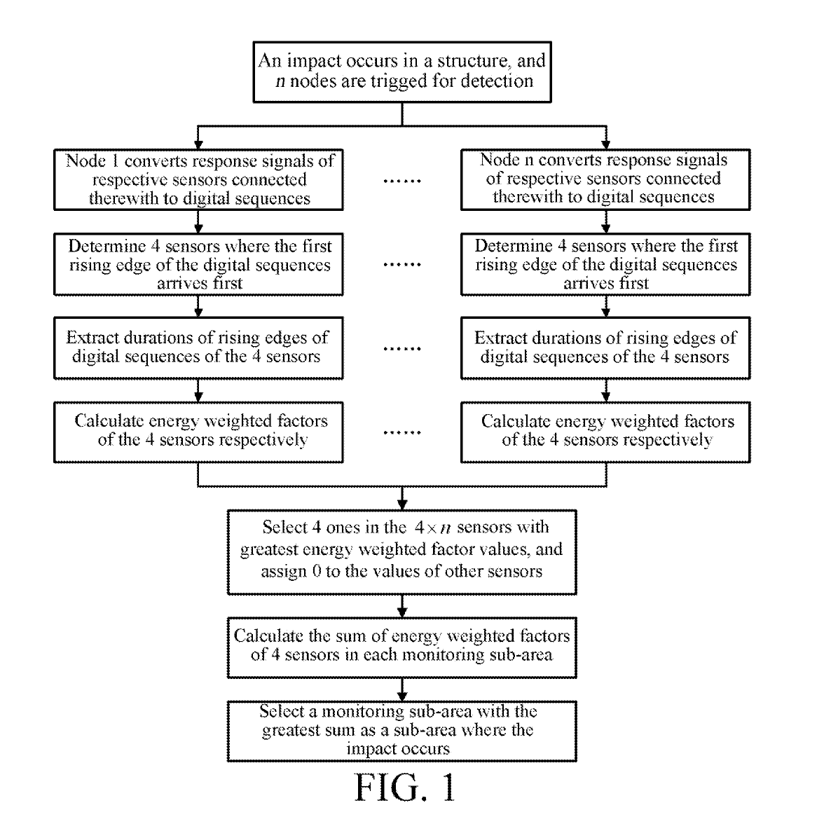

When an impact occurs, the localization process of the entire impact area is as shown in FIG. 1, which specifically includes the following steps:

(1) Monitoring nodes 1, 2, . . . , n are triggered, each triggered monitoring node converts response signals of impact sensors connected therewith to digital sequences, and each triggered monitoring node obtains a group of impact response signal digital sequences.

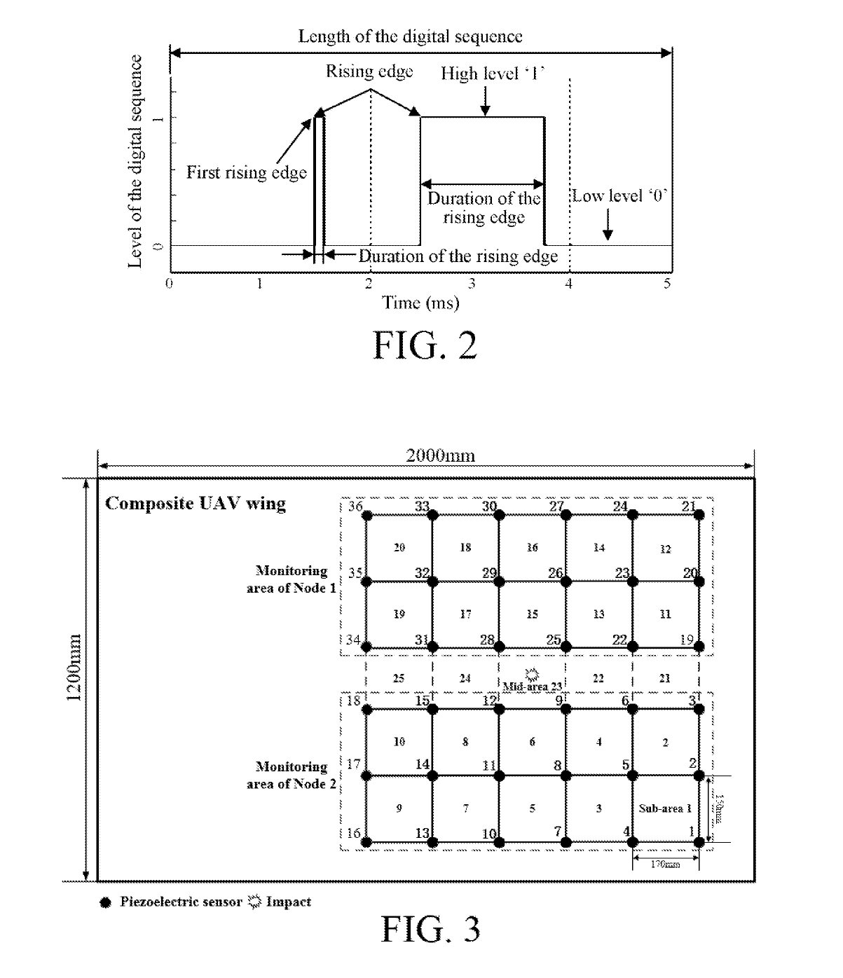

(2) The monitoring nodes 1, 2, . . . , n select 4 digital sequences where the first rising edge arrives first from the impact response signal digital sequences obtained respectively (for ease of description, herein the quadrilateral grid partition manner is taken as an example, and when another grid partition manner is adopted, the number of the selected digital sequences varies accordingly, for example, when a triangular grid is adopted, 3 digital sequences where the first rising edge arrives first are selected), and the sum of durations of all their respective rising edges is calculated. The first rising edge and duration of the rising edge of the digital sequence are defined as shown in FIG. 2.

(3) The monitoring nodes 1, 2, . . . , n respectively calculate energy weighted factors of the 4 impact sensors and upload the energy weighted factors to the monitoring center, and the monitoring center receives a total of 4×n energy weighted factors, corresponding to 4×n impact sensors. The energy weighted factors of the impact sensors are calculated according to the following formula:

$$E W F = \frac{D R}{I F R E}$$

in the formula, EWF is an energy weighted factor of an impact sensor, IFRE, index of the first rising edge, is a sequence number of arrival time of the first signal rising edge in the impact response signal digital sequence of the impact sensor in the selected 4 impact sensors, the value of IFRE of the impact sensor where the first signal rising edge arrives first is 1, the value of IFRE of the impact sensor where the first signal rising edge arrives second is 2, and so on; DR, duration of the rises, is the sum of durations of all signal rising edges in the digital sequence of the impact sensor, namely the total length of the high digital level of the digital sequence, the measuring unit of the durations herein may be second, millisecond, or microsecond, as long as the unit is uniform, and millisecond is preferably used in the present invention.

(4) The monitoring center selects 4 greatest ones from the energy weighted factors of the 4×n impact sensors, keeps the values of the energy weighted factors of the 4 impact sensors unchanged, and sets values of energy weighted factors of all other impact sensors as 0.

(6) The monitoring center calculates the sum of energy weighted factors of 4 impact sensors at vertices of each sub-area (i.e., grid cell) divided in the entire impact monitoring area, and the sub-area with the greatest sum is taken as the impact occurring sub-area.

To better describe the technical solution of the present invention, piezoelectric sensors and impact monitoring nodes are arranged on a composite UAV wing, to form a monitoring network to perform impact monitoring on the wing, so as to describe the specific implementation process of the method of the present invention.

As shown in FIG. 3, the size of the composite UAV wing is 2000 mm×1200 mm, and a total of 36 piezoelectric sensors are arranged on inner skin surfaces of the composite wing, which are recorded as Sensors 1 to 36. The Sensors 1 to 18 are connected with wireless impact monitoring Node 1, as shown in FIG. 3, and the Sensors 1 to 18 form 10 impact monitoring sub-areas, which are recorded as Sub-areas 1 to 10; the Sensors 19 to 36 are connected with wireless impact monitoring Node 2, which also form 10 impact monitoring sub-areas and are recorded as Sub-areas 11 to 20. In addition, the monitoring areas of Node 1 and Node 2 further have 5 mid-areas therebetween, which are recorded as Sub-areas 21 to 25. Each sub-area is encircled by 4 piezoelectric sensors, and the area is 170×150 mm².

Taking impact occurring on Sub-area 23 which is a mid-area as an example, the sub-area belongs to a mid-area, and thus both the impact monitoring nodes 1 and 2 will be triggered.

According to the execution mechanism of the impact localization algorithm shown in FIG. 1, the workflow of the entire monitoring network is as follows:

Node 1 is triggered, impact response signals of 18 piezoelectric sensors connected therewith are converted to digital sequences, there are a total of 18 digital sequences, and the length of each digital sequence is set as 1000 points.

Node 1 selects 4 digital sequences where the first rising edge arrives first from the 18 digital sequences, and calculates the sum of durations of their respective rising edges. In this example, the 4 sensors where the first rising edge of the digital sequences in all the sensors connected with Node 1 are Sensors 9, 12, 6 and 11 in sequence.

Node 1 respectively calculates energy weighted factors of the 4 piezoelectric sensors and uploads the energy weighted factors to the monitoring center wirelessly, and the values thereof are 2.92, 1.53, 0.71 and 0.49 respectively.

Node 2 simultaneously executes the above steps of the Node 1, the 4 sensors where the first rising edge of the digital sequences in all the sensors connected with the Node 2 are Sensors 28, 25, 29 and 26 in sequence, and the energy weighted factors of the 4 sensors are respectively 3.05, 1.47, 0.79 and 0.52.

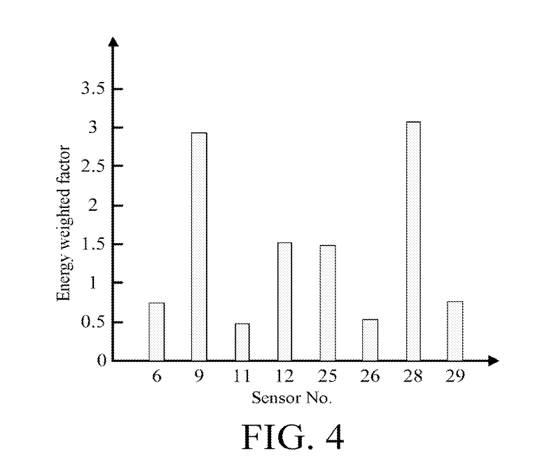

The monitoring center selects 4 greatest ones from the energy weighted factors of the 8 piezoelectric sensors, FIG. 4 lists the energy weighted factors of the 8 piezoelectric sensors, and it can be seen from the figure that 4 sensors with the greatest energy weighted factors are respectively Sensors 28, 9, 12 and 25. The values of the energy weighted factors of the Sensors 28, 9, 12 and 25 are kept unchanged, and the monitoring center sets values of energy weighted factors of all other 32 piezoelectric sensors as 0.

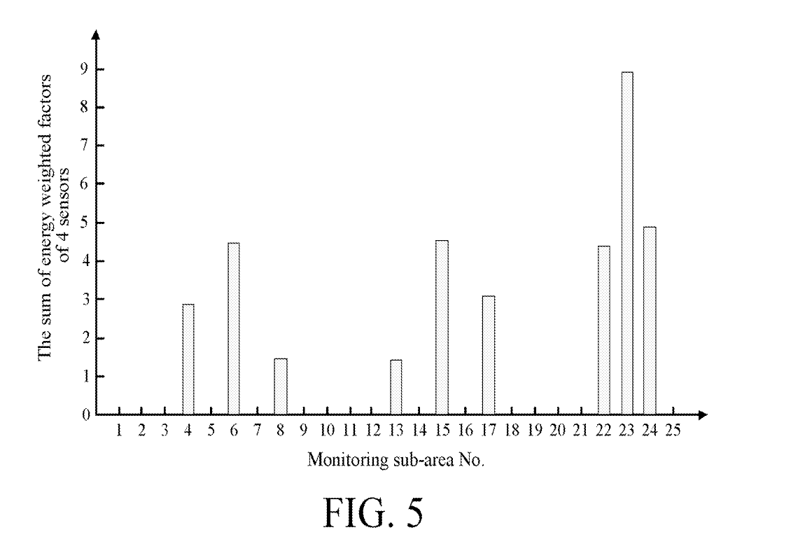

The sum of energy weighted factors of 4 piezoelectric sensors of each sub-area in all 25 sub-areas within the monitoring range is calculated, and the sub-area with the greatest sum is taken as the impact occurring sub-area. FIG. 5 shows distribution of the sum of energy weighted factors of each monitoring sub-area, and it can be seen from the figure that the sum of energy weighted factors of 4 sensors in the Sub-area 23 is the greatest and the Sub-area 23 is judged as the impact occurring sub-area, which agrees with the fact.

The present invention measures the degree of effects of an impact on each sensor within the monitoring range by defining a characteristic parameter called energy weighted factor, then uniformly evaluates degree of effects of the impact on all sub-areas and finally locates the impact occurring sub-area, solves the problems of localization confliction of adjacent nodes and mid-areas locating arising during large-scale networking monitoring, and can quickly and accurately perform impact locating on all sub-areas within the monitoring range. The present invention can meet the onboard application demands of large-scale online impact monitoring of a composite structure, and can promote the application and development of structural health monitoring and management systems in our country.

What is claimed is:

1. A method for locating an impact area of a composite structure based on an energy weighted factor, wherein at least two groups of impact sensor arrays are disposed in an impact monitoring area on the surface of the composite structure, the two groups of impact sensor arrays each are respectively in a signal connection with a monitoring node, and the monitoring nodes are in a signal connection with the same monitoring center; characterized in that, the method for locating an impact area comprises the following steps:
step A. using the position of each impact sensor disposed on the surface of the composite structure as a grid vertex, to grid-partition the impact monitoring area;
step B. when an impact occurs, receiving, by each one of n monitoring nodes triggered, an impact response signal digital sequence of each impact sensor connected therewith, and selecting first M impact sensors where a first signal rising edge in the impact response signal digital sequence arrives first, M being the number of vertices of a single grid cell partitioned in step A; then calculating respective energy weighted factors of the M impact sensors, and sending a calculation result to the monitoring center; the energy weighted factors of the impact sensors being calculated according to the following formula:
$$E W F = \frac{D R}{I F R E}$$
in the formula, EWF is an energy weighted factor of an impact sensor, IFRE is a sequence number of arrival time of the first signal rising edge in the impact response signal digital sequence of the impact sensor in the M impact sensors, and DR is the sum of durations of all signal rising edges in the impact response signal digital sequence of the impact sensor;
step C. selecting, by the monitoring center, first M ones in the n×M impact sensors with the greatest energy weighted factor value, keeping the energy weighted factor value of the M impact sensors unchanged, and setting all energy weighted factor values of all remaining impact sensors as 0; and
step D. determining, by the monitoring center, a sub-area where the impact occurs according to the sum of energy weighted factors of impact sensors at M vertices of each grid cell in the impact monitoring area; the grid cell with the greatest sum of energy weighted factors being the sub-area where the impact occurs.

2. The method for locating an impact area of a composite structure according to claim 1, characterized in that, the impact sensors are piezoelectric sensors.

3. The method for locating an impact area of a composite structure according to claim 1, characterized in that, quadrangular grid partition is performed on the impact monitoring area.

4. The method for locating an impact area of a composite structure according to claim 1, characterized in that, the monitoring center and the monitoring node are in a signal connection wirelessly.

5. The method for locating an impact area of a composite structure according to claim 1, characterized in that, in the formula of calculating the energy weighted factor, the unit of DR, i.e., the sum of durations of all signal rising edges in the impact response signal digital sequence of the impact sensor, is millisecond.
